(19) United States
(12) Patent Application Publication
(10) Pub. No.: US 2006/0039035 A1
(43) Pub. Date: Feb. 23, 2006

(54) Fax device for receiving and printing fax image data

(76) Inventors: Ya-Han Chuang, Hsinchu City (TW); Te-Chuan Hsieh, Kaohsiung City (TW)

Correspondence Address: RABIN & Berdo, PC, 1101 14TH STREET, NW, SUITE 500, WASHINGTON, DC, 20005, US

(21) Appl. No.: 11/198,155

(22) Filed: Aug. 8, 2005

(30) Foreign Application Priority Data
Aug. 23, 2004 (TW) 93125400

(51) Int. Cl. G06F 15/00

(52) U.S. Cl. 358/400; 358/1.15

(57) ABSTRACT

A fax device comprising a tray, a detecting unit, a faxing unit, a controlling unit and a printing unit is provided. The tray is for accommodating a printing medium. The faxing unit is for receiving fax image data with a page size. The detecting unit is for detecting size of the printing medium. The controlling unit is for processing the fax image data, according to the page size and the size of the printing medium, into a print image data with a print frame whose size is equal to or smaller than the size of the printing medium. The controlling unit is for controlling the printing unit to print the print image data onto the printing medium.

This application claims the benefit of Taiwan application Serial No. 93125400, filed Aug. 23, 2004, the subject matter of which is incorporated herein by reference.

### BACKGROUND OF THE INVENTION

1. Field of the Invention

The invention relates in general to a fax device for receiving and printing fax image data with a page size, and more particularly to a fax device which dynamically enlarges/reduces and prints the fax image data received according to the page size and the size of the printing medium placed in a tray of the fax device and the method for receiving and printing the fax image data.

2. Description of the Related Art

Living in modern times when technology advances rapidly, computer and computer peripherals have become indispensable elements to modern people's life. Computer peripherals include scanners, printers, fax machines, multi-functional machines, and so on. Take the fax machine for example: via a fax machine, the user can receive fax image data sent by others or send fax image data to others. Furthermore, the user can print the fax image data received via a fax machine.

A conventional fax machine prints the fax image data received onto a printing medium placed in a tray either directly or according to a certain reduction ratio. For example, when the fax machine receives a page of A4 sized image fax data but the printing medium placed in the tray of the fax machine is a letter sized printing medium, the fax machine will print the page of A4 sized image fax data onto two subsequent pages of letter-sized printing medium due to the fact that a letter-sized printing medium is shorter but wider than a A4-sized printing medium. Even if the fax machine reduces the size of the page of A4 sized image fax data according to a certain reduction ratio and the reduction-processed fax image data is processed into a print image data, the fax machine may still print the print image data onto two subsequent pages of letter-sized printing medium because the size of the print image data is larger than the size of the printing medium placed in the tray of the fax machine. Consequently, the two above methods for printing the image data received by a conventional fax machine have the inconsistency problem between the number of pages of fax image data received and the number of pages of printing medium printed, resulting in a waste of printing medium.

Since some fax machines had been programmed a predetermined printing medium reduction ratio before leaving the factory or the user can set the predetermined printing medium reduction ratio of the fax machine, the fax machine would reduce the fax image data received to a predetermined printing medium size, a letter size for instance. In situations when the size of the printing medium placed in the tray is different from the letter size predetermined by the fax machine, i.e., the printing medium placed in the tray is A4-sized or has a size smaller than the letter size, the image printed on the A4-sized printing medium would be too small or outside the eligible boundaries of the printing medium placed in the tray, severely affecting the printing quality of the received fax image data.

### SUMMARY OF THE INVENTION

It is therefore an object of the invention to provide a fax device for receiving and printing the fax image data. The design of dynamically enlarging/reducing and printing the received image data according to the page size of the fax image data and the size of the printing medium placed in the tray enables the number of pages of the print image data to be the same as the number of pages of the fax image data received and prevents the inconsistency between the number of pages printed and the number of pages of the fax image data received, which has resulted in a waste of printing medium.

According to an object of the invention, a fax device comprising a tray, a detecting unit, a faxing unit, a controlling unit and a printing unit is provided. The tray is for accommodating a printing medium. The faxing unit is for receiving fax image data with a page size. The printing unit is for printing the fax image data onto the printing medium. The detecting unit is for detecting size of the printing medium. The controlling unit is for processing the fax image data, according to the page size and the size of the printing medium, into a print image data with a print frame whose size is equal to or smaller than the size of the printing medium. The controlling unit is for controlling the printing unit to print the print image data onto the printing medium.

According to another object of the invention, a fax device comprising a fax module and an external print module is provided. The external print module is electrically connected to and is communicated with the fax module. The external print module comprises a printing unit, a tray, a detecting unit and a first controlling unit. The tray is for accommodating a printing medium. The fax module comprises a faxing unit and a second controlling unit. The detecting unit is for detecting size of the printing medium. The first controlling unit is for obtaining the size of the printing medium via the detecting unit and controlling the printing unit. The faxing unit is for receiving a fax image data with a page size. The second controlling unit is for obtaining the size of the printing medium via the first controlling unit, processing the fax image data, according to the page size and the size of the printing medium, into a print image data with a print frame whose size is equal to or smaller than the size of the printing medium. The second controlling unit is for controlling the printing unit to print the print image data onto the printing medium via the first controlling unit.

Other objects, features, and advantages of the invention will become apparent from the following detailed description of the preferred but non-limiting embodiments. The following description is made with reference to the accompanying drawings.

### BRIEF DESCRIPTION OF THE DRAWINGS

FIG. 1A is a block diagram of a fax device according to a first embodiment of the invention;

FIG. 1B is a structural diagram of a fax device according to a first embodiment of the invention;

FIG. 2A is a block diagram of a fax device according to a second embodiment of the invention; and

FIG. 2B is a structural diagram of a fax device according to a second embodiment of the invention.

### DETAILED DESCRIPTION OF THE INVENTION

First Embodiment

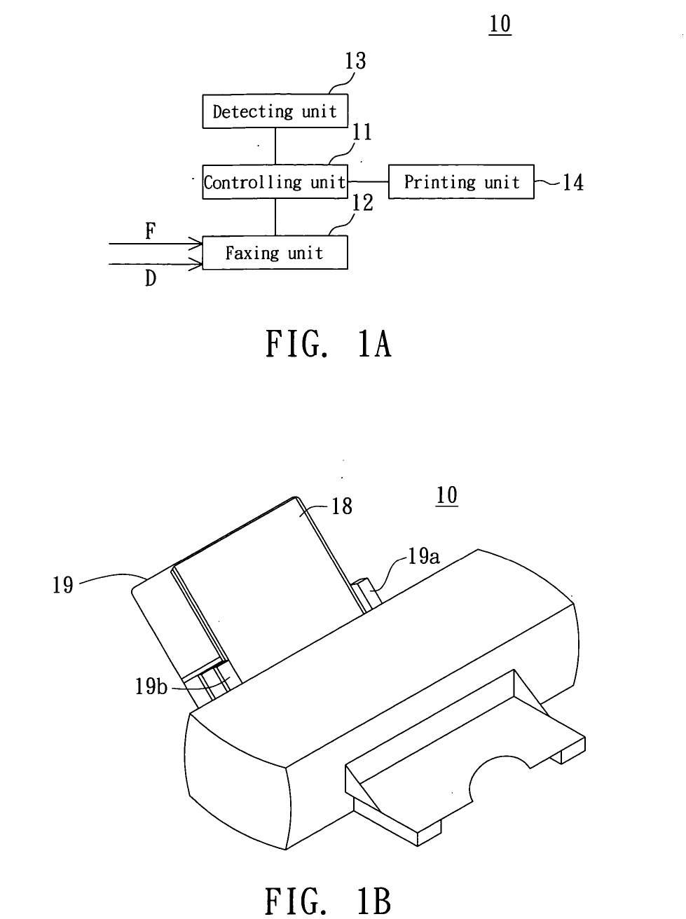

Referring to FIGS. 1A˜1B, a block diagram and a structural diagram of a fax device according to a first embodiment of the invention are respectively illustrated. In FIGS. 1A˜1B, the fax device 10 comprises a tray 19, a detecting unit 13, a faxing unit 12, a controlling unit 11 and a printing unit 14. The tray 19 is for accommodating a printing medium 18. Two guiders 19a and 19b are movably disposed on the tray 19 for accommodating the printing medium 18 tightly in the tray 19, so that the printing medium 18 is positioned in the tray 19. Besides, the detecting unit 13 is for detecting the size of the printing medium 18. The faxing unit 12 is for receiving fax image data F with a page size via a telephone line or a wireless network. The controlling unit 11 obtains the size of the printing medium 18 via the detecting unit 13. The controlling unit 11 is electrically connected to the detecting unit 13, the printing unit 14 and the faxing unit 12. The controlling unit 11 controls the operation of the detecting unit 13, the printing unit 14 and the faxing unit 12. The controlling unit 11 is for processing the fax image data F, according to the page size and the size of the printing medium 18, into a print image data with a print frame whose size is equal to or smaller than the size of the printing medium. Besides, the controlling unit 11 controls the printing unit 14 for the printing unit 14 to print the print image data onto the printing medium 18.

The processing methods for the controlling unit 11 to process the fax image data F into the print image data according to the page size and the size of the printing medium 18 are elaborated below.

In the first processing method, when the page size of the fax image data F is determined to be larger than the size of the printing medium 18 by the controlling unit 11, the controlling unit 11 reduces the fax image data F, so that the size of the print frame is equal to or smaller that the size of the printing medium 18.

In the second processing method, when the page size of the fax image data F is determined to be smaller than the size of the printing medium 18 by the controlling unit 11, the controlling unit 11 enlarges the image data, so that the size of the print frame is equal to or smaller than that of the printing medium 18.

In the third processing method, when the page size of the fax image data F is determined to be equal to the size of the printing medium 18 by the controlling unit 11, the controlling unit 11 processes the fax image data F into the print image data, and the size of the print frame is equal to that of the printing medium 18.

In the fourth processing method, when the page size of the fax image data F is determined to be equal to the size of the printing medium 18 by controlling unit 11, the controlling unit 11 reduces the fax image data F according to a reduction ratio, so that the size of the print frame is smaller than that of the printing medium 18. The reduction ratio, which is smaller than 100%, is preferably equal to 95%.

Of the above processing methods, the controlling unit 11 enlarges or reduces the fax image data F to fit the size of the printing medium 18 by enlarging or reducing a long edge, a short edge, or both the long edge and the short edge, so that the size of the print frame is smaller than or equal to that of the printing medium 18.

Besides, the controlling unit 11 further has an image cropping function. For example, when the faxing unit 12 receives fax image data D with a first page size. The controlling unit 11 truncates the blank region of the fax image data D via the image cropping function, so that the fax image data D is truncated into a first fax image data with a second page size. The second page size is smaller than the first page size. The controlling unit 11 processes the fax image data D, according to the second page size and the size of the printing medium 18, into a first print image data with a first print frame whose size is equal to or smaller than the size of the printing medium 18. Besides, the controlling unit 11 controls the printing unit 14 to print the first print image data onto the printing medium. The processing method for the controlling unit 11 to process the fax image data D into the first print image data according to the second page size and the size of the printing medium 18 is the same with the method for the controlling unit 11 to process the fax image data F into the print image data according to the page size and the size of the printing medium 18, and is not repeated here.

When the fax device 10 receives any fax image data, the fax device 10, according to the size of the printing medium 18 currently placed in the tray 19, performs fax image data enlargement/reduction and printing, or performs printing directly without performing image enlargement/reduction first, or performs reduction according to a certain ratio and prints. For example, when the fax device 10 receives a page of A4 sized fax image data, the fax device 10 would automatically detect the size of the printing medium 18 currently placed in the tray 19. If the printing medium 18 is also A4 sized, the fax device 10 would directly print the fax image data onto the printing medium 18, or reduce the fax image data according to a reduction ratio, then print the print image data onto the printing medium 18. If the printing medium 18 is letter sized, due to the fact that a letter sized printing medium is shorted but wider than an A4 sized printing medium, the fax device 10 would automatically reduce the fax image data to fit a letter sized page first, then prints the print image data onto the letter-sized printing medium 18.

When the fax device 10 receives a page of letter sized image fax data, but the printing medium 18 is A4 sized, due to the fact that a letter sized printing medium is shorter but wider than a A4 sized printing medium, the fax device 10 would automatically enlarge the fax image data to fit A4 size, then print the print image data onto an A4-sized printing medium 18. Besides, in the present embodiment, the number of pages of the fax image data received by the fax device 10 is the same with the number of pages of the print image data.

Second Embodiment

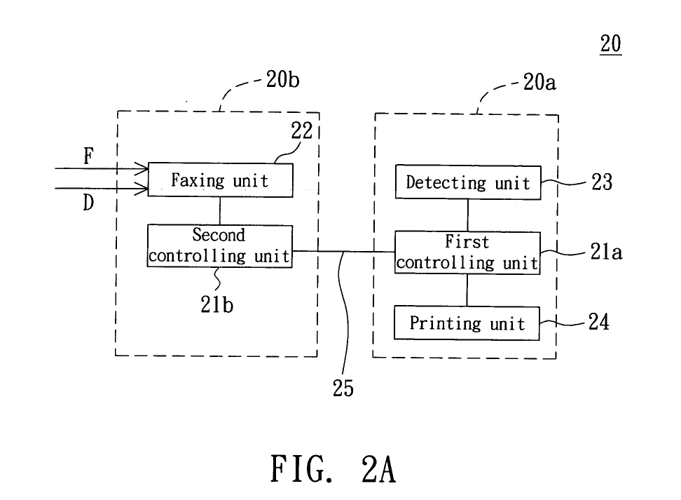

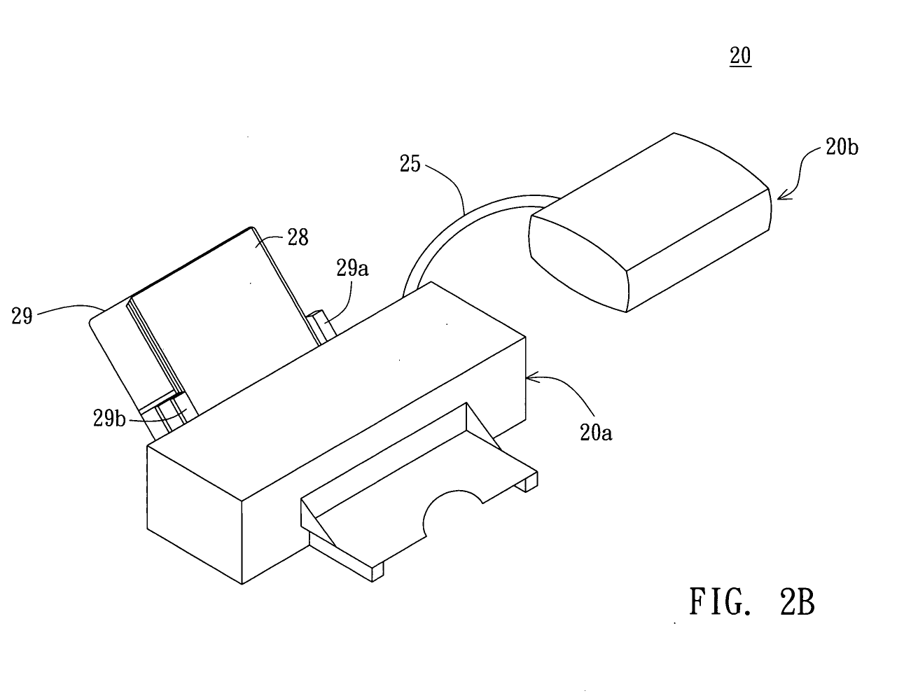

Referring to FIGS. 2A to 2B, a block diagram and a structural diagram of a fax device according to a second embodiment of the invention are illustrated. In FIG. 2A˜2B, the fax device 20 comprises a fax module 20b and an external print module 20a. The fax module 20b is electrically connected to and is communicated with the external print module 20a via a signal line 25. The external print module 20a comprises a tray 29, a detecting unit 23, a first controlling unit 21a, and a printing unit 24. The fax module 20b comprises a faxing unit 22 and a second controlling unit 21b. The tray 29 is for accommodating a printing medium 28. Two guiders 29a and 29b are movably disposed in the tray 29 for accommodating the printing medium 28 tightly in the tray 29, so that the printing medium 28 is positioned in the tray 29. Besides, the detecting unit 23 is for detecting size of the printing medium 28. The first controlling unit 21a obtains the size of the printing medium 28 via the detecting unit 23 and controlling the printing unit 24. The faxing unit 22 is for receiving fax image data F with a page size via a telephone line or a wireless network. The second controlling unit 21b is communicated with the first controlling unit 21a via the signal line 25 and obtains the size of the printing medium 28 via the first controlling unit 21a.

The second controlling unit 21b is for processing the fax image data F, according to the page size and the size of the printing medium 28, into a print image data with a print frame whose size is equal to or smaller than the frame of the printing medium 28. Besides, the second controlling unit 21b controls the printing unit 24 via the first controlling unit 21a to print the print image data onto the printing medium 28. The processing method for the second controlling unit 21b to process the fax image data F into a print image data according to the page size and the size of the printing medium 28 is the same with the method for the controlling unit 11 of the first embodiment to process the fax image data F into a print image data according to the page size and the size of the printing medium 18, and is not repeated here. Besides, the second controlling unit 21b enlarges/reduces the fax image data F to the size of the printing medium 28 by enlarging/reducing a long edge, a short edge, or both the long edge and the short edge, so that the enlarged/reduced a fax image data F is processed into the print image data and the size of the print frame is smaller than or equal to the size of the printing medium 28.

Besides, the second controlling unit 21b further has an image cropping function. For example, the faxing unit 22 receives fax image data D with a first page size. The second controlling unit 21b truncates the blank region of the fax image data D via the image cropping function, so that the fax image data D is truncated into a first image data with a second page size. The second page size is smaller than the first page size. The second controlling unit 21b is for processing the fax image data D, according to the second page size and the size of the printing medium 28, into a first print image data with a first print frame whose size is equal to or smaller than the size of the printing medium 28. Besides, the second controlling unit 21b, via the first controlling unit 21a, controls the printing unit 24 to print the first print image data onto the printing medium. The processing method for the second controlling unit 21b to process the fax image data D into the first print image data according to the second page size and the size of the printing medium 28 is the same with the method for the controlling unit 11 of the first embodiment to process the fax image data F into the print image data according to the page size and the size of the printing medium 18, and is not repeated here.

The fax device for receiving and printing a fax image data disclosed in above embodiments of the invention, with the design of dynamically enlarging/reducing and printing fax image data according to the page size of the fax image data and the size of the printing medium, enables the number of pages of the print image data to be the same as the number of pages of the fax image data received and prevents the inconsistency between the number of pages printed and the number of pages of fax image data received, which has resulted in a waste of printing medium. Consequently, the printing quality of the fax image data of the fax device as well as the practicability of the fax device can both be largely improved

While the invention has been described by way of example and in terms of a preferred embodiment, it is to be understood that the invention is not limited thereto. On the contrary, it is intended to cover various modifications and similar arrangements and procedures, and the scope of the appended claims therefore should be accorded the broadest interpretation so as to encompass all such modifications and similar arrangements and procedures.

What is claimed is:

1. A fax device, comprising:
a tray for accommodating a printing medium;
a faxing unit for receiving fax image data with a page size;
a printing unit for printing the fax image data onto the printing medium;
a detecting unit for detecting size of the printing medium; and
a controlling unit for processing the fax image data, according to the page size and the size of the printing medium, into a print image data with a print frame whose size is equal to or smaller than the size of the printing medium, and controlling the printing unit to print the print image data onto the printing medium.

2. The device according to claim 1, wherein the controlling unit reduces or enlarges the fax image data, so that the size of the print frame is equal to or smaller than that of the printing medium.

3. The device according to claim 1, wherein the controlling unit reduces the fax image data according to a reduction ratio, so that the size of the print frame is smaller than that of the printing medium.

4. The device according to claim 3, wherein the reduction ratio is smaller than 100%.

5. The device according to claim 1, wherein the controlling unit truncates the blank region of the fax image data via an image cropping function.

6. A fax device, comprising:
an external print module, comprising:
a tray for accommodating a printing medium;
a printing unit;
a detecting unit for detecting size of the printing medium; and
a first controlling unit for obtaining the size of the printing medium via the detecting unit and controlling the printing unit; and
a fax module which is electrically connected to and is communicated with the external print module, wherein the fax module comprises:
a faxing unit for receiving fax image data with a page size; and
a second controlling unit for obtaining the size of the printing medium via the first controlling unit, processing the fax image data, according to the page size and the size of the printing medium, into a print image data with a print frame whose size is equal to or smaller than the size of the printing medium, and controlling the printing unit to print the print image data onto the printing medium via the first controlling unit.

7. The device according to claim 6, wherein the second controlling unit reduces or enlarges the fax image data, so that the size of the print frame is equal to or smaller than that of the printing medium.

8. The device according to claim 6, wherein the second controlling unit reduces the fax image data according to a reduction ratio, so that the size of the print frame is smaller than that of the printing medium.

9. The device according to claim 8, wherein the reduction ratio is smaller than 100%.

10. The device according to claim 6, wherein the second controlling unit truncates the blank region of the fax image data via an image cropping function.
